(19) United States
(12) Patent Application Publication
(10) Pub. No.: US 2005/0026129 A1
(43) Pub. Date: Feb. 3, 2005

(54) Interactive computerized performance support system and method

(76) Inventor: Kevin B. Rogers, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/877,502

(22) Filed: Jun. 25, 2004

Related U.S. Application Data
(63) Continuation of application No. PCT/US02/41842, filed on Dec. 30, 2002.
(60) Provisional application No. 60/346,436, filed on Dec. 28, 2001.

(51) Int. Cl. G09B 7/00; G09B 3/00; G06F 17/00; G06N 7/08; G06N 7/00

(52) U.S. Cl. 434/322

(57) ABSTRACT

An interactive computerized support system provides performance support using a remote user device connected via a network to a database having multiple objects stored as knowledge clusters. User tasks are organized according to a process model having one or more sub-tasks. The knowledge required to perform each of the tasks is organized according to a reference information model that includes the data and information that correlates with a particular task in the process model. Knowledge clusters are generated to represent fundamental building blocks of knowledge accessible through the reference information model. Server side hardware interfaces to the network and receives user device requests for data and retrieves the process model data, reference information model data, and knowledge clusters and links the information together and transmits the information to the user device.

This application is a continuation of International Application No. PCT/US02/41842 filed Dec. 30, 2002, which claims the benefit under 35 USC § 119(e) of U.S. Provisional Application No. 60/346,436, filed Dec. 28, 2001.

### BACKGROUND OF THE INVENTION

1. Field of the Invention

This invention relates to computerized e-learning and training systems. More particularly, this invention relates to electronic performance support systems.

2. Description of the Related Art

Historically, students, especially students in a technology maintenance discipline, have been taught their job tasks by means of traditional training utilizing appropriate “how-to” manual content in formal classrooms or through individual study. These how-to manuals are written to provide a step-by-step guidance, with illustrative pictures and drawings, of how to perform the diagnostic or repair task.

Traditional classroom study typically is preferred over individual correspondence-type study because of the ability to interact with the classroom instructor. One distinct advantage of classroom study is that the teacher parses the content to be taught. The instructor can parse the content to specifically address a student's query or contextual need. Active participation in interactive sessions with the instructor more quickly and thoroughly enables a student to learn a particular task than what could be achieved by simply studying books or procedure manuals.

Additionally, in many professions and trades, the novice workers, after completing classroom studies, work under the tutelage of an expert during an apprenticeship. The expert thus serves as a mentor to the apprentice. The expert is available to answer questions on demand relative to the worker's task as may be asked by the worker from time to time. Thus, the apprentice is, on the one hand, able to perform meaningful work or tasks that are already known. On the other hand, the apprentice is able to obtain the help of an expert mentor as needed for more complicated tasks which have yet to be learned adequately or for tasks that were once trained and forgotten.

Presently, there exist many computerized teaching systems for teaching apprentices certain tasks. The most basic system consists of computerized instruction manuals that are appropriately indexed and that typically include a search engine for locating relevant topics to an area of inquiry. Still other teaching systems, such as that disclosed in U.S. Pat. No. 5,782,642 entitled “Interactive Video and Audio Display System Network Interactive Monitor Module Interface”, provide teaching functions that are utilized for explaining or demonstrating particular functions of a software application running on the associated computer without interfering with such software. Still other systems that reference guided teaching are disclosed in U.S. Pat. No. 4,052,798 entitled “Audio-Visual Teaching System”; U.S. Pat. No. 5,782,642 entitled “Interactive Video and Audio Display System Network Interactive Monitor Module Interface”; U.S. Pat. No. 5,918,010 entitled “Collaborative Internet Data Mining Systems”; U.S. Pat. No. 5,954,510 entitled “Interactive Goal-Achievement System and Method”; U.S. Pat. No. 5,975,081 entitled “Self-Contained Transportable Life Support System”; U.S. Pat. No. 6,039,688 entitled “Therapeutic Behavior Modification Program, Compliance Monitoring and Feedback System” and U.S. Pat. No. 3,654,708.

Unfortunately, the aforementioned computerized teaching systems do not provide their proposed value in a versatile and universal manner that are adaptable to a variety of industries. Furthermore, the presently known computerized teaching systems do not provide various levels of detailed information as may be needed for each particular task nor are they context sensitive to the temporal-related actions of the worker. Rather, computerized teaching systems usually relate to the particular knowledge for which they were especially created. They typically present their information in a sequenced approach without the ability on the part of the user to select the desired level of detailed information needed for a particular task or to receive that information in an task-based manner.

### SUMMARY OF THE INVENTION

It is one object of this invention to provide an improvement which overcomes the aforementioned inadequacies of the prior art systems and provides an improvement which is a significant contribution to the advancement of the computerized teaching art.

Other objectives of this invention are to 1) provide a computerized performance support system that are equally as useful for apprentices as well as experienced individuals; 2) which is versatile and malleable enough and which includes a common methodology and process that allows it to be utilized across many industries; and 3) that provides performance support functions in which the user may select the desired level of detailed information needed for a particular task, among other benefits.

These objects should be construed to be merely illustrative of some of the more prominent features and applications of the intended invention. Many other beneficial results can be attained by applying the disclosed invention in a different manner or modifying the invention within the scope of the disclosure.

An interlocking system of tools, processes and methodologies, collectively referred to as a knowledge stream is disclosed. The system allows for the designing, creating, and implementing of performance support systems that enable receiving and controlling information to and from users for the purpose of guiding the user through a series of job tasks or operations to achieve enhanced productivity and accuracy.

These tools, processes and methodologies utilized to create a knowledge stream system include work flow and work environment analysis techniques; processes and tools used to create a process model and reference information model from the work environment analysis resulting in a knowledge design of the system; a developed knowledge cluster—a combination of task, reference and any training required to achieve a particular task in a sequence of tasks that will provide real-time learning and execution; an interface architecture that embodies the knowledge design and the knowledge cluster and is ergonomically suited to the work environment; multimedia application software to house the interface design that supports the display of text and picture-based representations, including full motion video, frame based displays of both Web-oriented content and standard interface components and navigation features for control of information presentation and feedback from the user; multi-modal input ability including full duplex voice recognition software for both command and navigation purposes as well as natural language processing for notation and data input; a database design and data conversion methodology for the for the conversion and storage of existing data and information in digitized object format for use in the performance support system referred to as a knowledge store; an advanced Web server-based middleware that assembles and delivers, at high speed, data from the object-oriented database and delivers it to the aforementioned software interface of the user's client device.

### BRIEF DESCRIPTION OF THE DRAWINGS

For a fuller understanding of the nature and objects of the invention, reference should be made to the following detailed description as it relates to the accompanying figures.

FIG. 1 is a functional block diagram of a knowledge stream system.

FIG. 2 is a functional block diagram of a user device for use in a knowledge stream system.

FIG. 3 is a flowchart of a knowledge stream development.

FIG. 4 is a flowchart of a knowledge design development.

FIG. 5 is a functional block diagram of a knowledge cluster.

FIG. 6 is a functional block diagram of interlinked knowledge clusters.

FIG. 7 is an embodiment of a user device display.

FIG. 8 is a flowchart of a knowledge design process in a user device.

FIG. 9 is a flowchart of a knowledge design process in server side hardware.

### DETAILED DESCRIPTION OF THE PREFERRED EMBODIMENT

The knowledge stream system construction is a multi-step process that involves several disciplines and several precedent steps that expose the actual construction of the software for each application. The software and resulting application of the software embodies the standard components of the knowledge stream development methodology but each industry or manufacturer will be equipped with slight variations in the interface outcome based on process variations those industries and manufacturers possess.

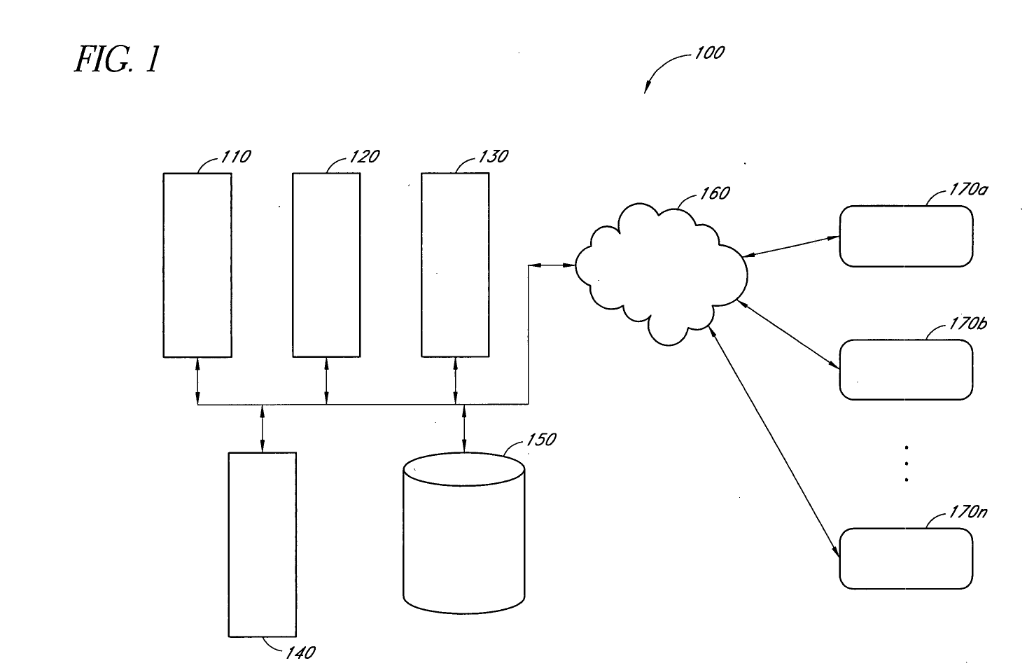

FIG. 1 is a functional block diagram of a knowledge stream system 100. The knowledge stream system 100 includes server side hardware connected to user devices 170a-170n using a network 160.

The system includes multiple servers 110, 120, 130, and 140 in communication with each other and in communication with a database 150. The servers 110, 120, 130, 140 and the database 150 are also in communication with a network 160. Multiple user devices 170a-170n are also in communication with the network 160 and thus can communicate with the servers 110, 120, 130, 140, and can access the database 150.

The knowledge stream system 100 is configured to provide an interactive training and performance support system for users of a user device, for example 170a. The system 100 serves as a work productivity aid by delivering a focused, context sensitive information stream that can be immediately converted into knowledge at the point of use at the work site by its user, thereby increasing user productivity and accuracy.

User tasks are configured during design of the knowledge stream system 100 according to a process model. The process model can include multiple sub-tasks with each of the sub-tasks requiring various user skill levels. The individual sub-tasks can be further isolated into fundamental tasks, or fundamental building blocks. The knowledge stream system 100 includes a database of pertinent knowledge stored as small fundamental building blocks of knowledge that are termed “knowledge clusters”. The knowledge clusters are dynamically linked together when the user, via a user device 170a, requests support for performance of a particular task. The user device 170a then presents the knowledge clusters in an interactive manner depending on user input.

A user, via a user device 170a, can request performance support for a particular task. The user device 170a retrieves from the database 160 a process model associated with the task. The user can then navigate through the process model to access the various knowledge clusters in order to perform the task. An advanced user may access only those knowledge clusters corresponding to advanced level instruction, while a novice can access those knowledge clusters that provide detailed instruction regarding the performance of each of the tasks in the performance model.

The knowledge stream system 100 design is dependent on the environment that it is designed to support. For example, a knowledge stream system 100 designed to support automotive repair will differ from a knowledge stream system 100 designed to support patient diagnosis. Although the actual system 100 configuration can vary depending on the support environment, a typical system 100 includes the fundamental architecture shown in FIG. 1.

Although four servers, 110, 120, 130, and 140 are shown in the knowledge stream system 100, additional servers can be added to the system 100 to perform functions other than those described below. Alternatively, some or all of the functions of the servers 110, 120, 130, and 140 can be performed in fewer servers or can be performed in a greater number of servers.

A first server is a knowledge design server 110. The knowledge design server 110 is configured to perform the work flow and work environment analysis and the design of the framework into which the knowledge clusters will be contained. The knowledge design server 110 is typically used during the design of the knowledge stream system 100 and may be omitted from a system 100 that is complete and provides the desired performance support functions.

The knowledge design server 110 can, for example, include a questionnaire that is structured to uncover the workflow, spatial settings, and other workflow parameters associated with a particular task. Numerous workers in the target industry can fill out the questionnaire. The knowledge design server 110 can then categorize the various workflow and work environment information into a framework.

The framework can include, for example, process models, reference information models, and conceptual support models that are associated with tasks. After the various models are defined in the knowledge design server 110, the actual performance support information is compiled.

Some of the performance support information is created during the design of the knowledge stream system 100. Other pieces of information can be converted from legacy data. Legacy data can, for example, include printed manuals, electronic manuals, print and electronic guides, and multimedia presentations.

A second server is a legacy database conversion server 120 that is configured to take the legacy data and convert it for use in the knowledge stream system 100. For example, printed legacy data can be scanned and categorized as text, graphical images, tables, or a combination of text and graphical images. As was the case with the knowledge design server 110, the legacy database server 120 may be omitted in systems that do not require further conversion of legacy data.

The legacy database server 120 controls the extraction of the information, for example, by an electronic scanner (not shown). The legacy database server 120 can, for example, perform optical character recognition to translate printed text into electronic format. The legacy database server 120 can more easily extract data that is in an electronic format. The legacy database server 120 then stores the extracted legacy data in the database 150. The legacy database server 120 is configured to deposit the information in the database 150 according the framework developed by the knowledge design server 110.

A process server 130 operates to dynamically link various elements of knowledge stored in the database 150 as performance support is requested by a user device. The database 150 can include a vast amount of data to support an enormous number of tasks that may be the subject of performance support. The process server 130 operates to link those elements of knowledge that relate to a performance support request. Thus, the process server 130 can identify and link the knowledge required for performance of a diagnostic task in an automotive repair environment. The particular blocks of knowledge can then be provided to a user device, for example 170a, in response to requests.

A network host 140 operates as a network interface. The network host 140 can communicate with the user devices 170a-170n and can communicate some or all of the data linked by the process server 130 for each performance support request. The network host 140 can, for example, perform authentication of user devices 170a-170n and can control access of the database 150 by the user devices 170a-170n. The host server 140 can communicate with the user devices 170a-170n over the network 160 using communication protocols. The communication protocols can include, for example, http and XML streams. The host server 140 can format the data as web pages that are compatible with a web browser in the user device. The data can then be transmitted to the user device as web pages.

The database 150 can be any type of memory having sufficient storage for the knowledge data. For example, the database 150 can include RAID storage arrays, hard disk storage, CD-ROM banks, memory chips, and the like, or any other means for storage. The database 150 can store the knowledge data for one or more categories of tasks. For example, where the knowledge stream system 100 is accessible over a wide area network, the database 150 can store the knowledge data for a variety of users. However, where the knowledge stream system 100 is designed to be used in a local area network, the database can store a subset of a knowledge database, such as, only the performance support for a single make of automobile. The database 150 can store the data as objects. The data can be stored in any format that is compatible with the hardware and processes used by the server side hardware. For example, the database can be a SQL database.

The network 160 can be a local area network or can be a wide area network. For example, where the servers 110, 120, 130, and 140 and database 150 are housed in a location that is near the user devices 17a-170n, such as in an automobile dealership, the network 160 can be a local area network. Where the servers 110, 120, 130, and 140 and database 150 are housed in a location remote from the user devices 170a-170n, such as with a centralized database, the network 160 can be a wide area network, such as the Internet.

The user devices 170a-170n can access the database 150 over the network 160 in order to access the knowledge stored in the database 150. Each of the user devices 170a-170n can communicate with the network, for example, using a wired communication link or a wireless communication link. The user devices 170a-170n receive commands from user and generate requests for performance support data. The performance support data is retrieved from the database 150 and provided to the user devices 170a-170n where the information can be selectively displayed or otherwise presented to the user.

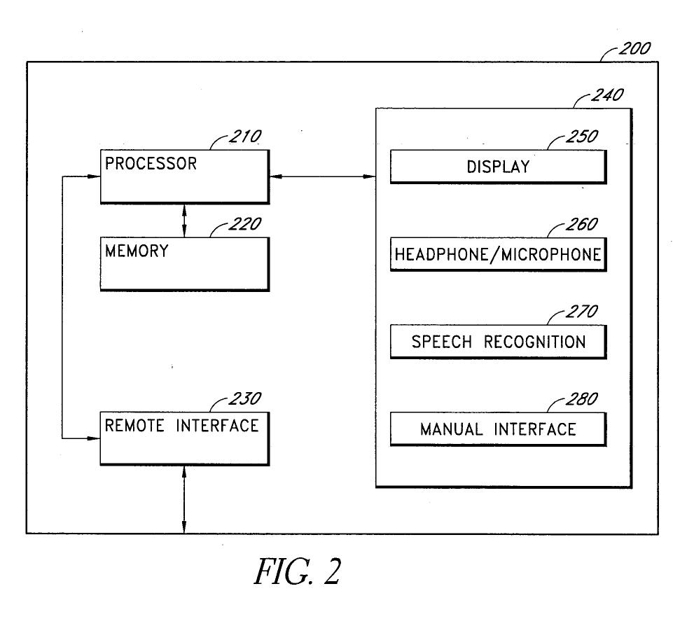

FIG. 2 is a functional block diagram of a user device 200. The user device 200 can, for example, be one of the user devices 170a-170n of the knowledge design system 100 of FIG. 1. The user device 200 can be a stationary device or can be a portable device. When the user device 200 is a portable device, the user device 200 can be a handheld device, a tablet, or a notebook device.

The user device 200 includes a processor 210 connected to memory 220 and a remote interface 230. The processor 210 is also connected to a user interface 240. The user interface 240 includes a display 250, audio input and audio output device that for example, can be a headphone/microphone combination 260, a speech recognition module 270, and a manual interface 280, that can include a keypad, keyboard, slide, knob, button, switch, touch screen, and the like, or other means for input.

The user device 200 accepts user commands and user requests for performance support information via the user interface 240. The user commands are communicated to the processor 210. The processor 210 can then determine if the performance support information is stored in memory 220 or if the information is to be retrieved from the remote database. The processor 210 can run a web browser application stored in the memory as a series of instructions. The processor 210 running the web browser can format the data as web pages for presentation on the display 250.

The processor 210 controls the remote interface 230 to communicate with the server side hardware over a network connection. The remote interface 230 provides the interface to the network. The remote interface can interface with the network using a wired communication link or can communicate with the network using a wireless communication link. The remote interface 230 can, for example, be a network interface card, a modem, or some other means for communication. The remote interface 230 communicates using a cable connected to the network when the communication link is a wired communication link. For example, the remote interface 230 can communicate with the network using an Ethernet cable. The remote interface 230 can communicate with the network using a wireless communication link, such as a radio frequency (RF) link or an optical link. The remote interface 230 can communicate with the network, for example, using an IEEE 802.11 wireless communication link.

Performance support knowledge that is retrieved from the database can be stored in the memory 220. The processor 210 can then selectively present the knowledge data depending on user commands. For example, a user can request a specific schematic be presented on the display 250, or the user can request instructions for a specific diagnostic process.

Visual output is presented to the user via the display 250, while audio output 260 is provided using the headphone 260 or some other speaker. Input to the user device 200 can be via the manual interface 280 or via the microphone 260. Spoken commands can be accepted by the microphone 260 and converted into electrical signals to be analyzed by the speech recognition module 270. The speech recognition module 270 can convert the spoken user commands into electronic requests that can be handled by the processor.

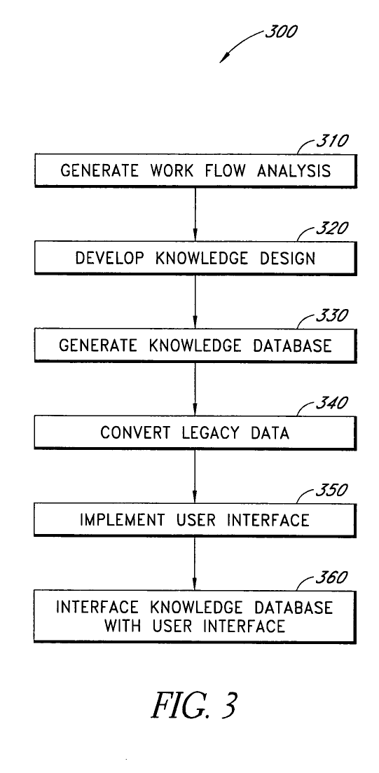

The seamless knowledge stream that the user can access via a user device 200 is prepared using a database storage, retrieval, and presentation system that is customized for the particular industry. The process of creating the seamless knowledge stream experienced by the end user is shown in FIG. 3.

FIG. 3 is a flowchart of the process 300 of creating a knowledge stream database for use in a knowledge stream system, such as the system shown in FIG. 1. The process 300 can, for example be embodied as processor readable instructions stored in memory. A processor can operate on the instructions to carry out the process 300. The creation of the seamless knowledge stream experienced by the user typically requires numerous actions that are not seen by the end user.

The process 300 of creating a knowledge stream database begins with generating a work flow analysis 310. Before work can begin on the knowledge stream software itself a work flow and work environment analysis is performed to determine what types of actions the user engages in and what the work environment is comprised of. This composite analysis forms an integrated part of the overall process and is performed with the complete system in mind. Because of its impact on the resulting system the work flow and work environment analysis engaged in is atypical in nature and is specific to developing a knowledge stream system for a particular application.

A work flow is broken down into work events and work tasks. A work event is a work component comprised of one or more work tasks. An example of a work event would be a voltage measurement. Work tasks would be the discrete steps or tasks to accomplish the voltage measurement.

In analyzing the work events and tasks of the workers a series of questions can be asked to isolate the movements of the workers relative to the system requirements. Movements of the worker, what tools are needed, how actual tasks are executed, of what type of spatial setting is typical, even what kind and concentration of lighting is employed, are all factors in the determination of work flow and workplace parameters. Work events and tasks are then analyzed in context to the work environment to understand how the work events and tasks are affected by the environment and how the knowledge stream system platforms and user interface can be configured to accommodate these variables. This function can be performed, for example, in a series of questionnaires controlled by a knowledge design server. Alternatively, a work flow audit can be performed and the results summarized.

From a content and scope perspective the work flow and work environment analysis questions are designed to support the knowledge design of the system and rely upon knowledge of Industrial Psychology, general technology, worker behavior, e-learning principles, interface design constructs, knowledgebase design methods and Web delivery technologies directly related to the process of assembling the knowledge stream system.

The answers to the hundreds of workflow analysis questions provides input to the individual knowledge design to help shape the custom software interface of the specific application. Following generation of the work flow analysis 310 a knowledge design is developed 320.

The knowledge design is essentially the rough framework of how the knowledge will be conveyed to the user. The knowledge design can reflect the results of the workflow and work environment analysis and can be coupled with the mass of informational content provided by a customer. The primary components of the knowledge design are the Process Model, the Reference Information Model, and the Conceptual Support Model.

The knowledge design provides an ability to supply information in a manner that reduces the time necessary for the conversion of that information into knowledge. In other words, the knowledge design endeavors to create a “stream of knowledge” for a worker.

After development of the knowledge design, a knowledge database is generated 330. legacy data can be converted 330 and stored in the database.

The knowledge database design and the conversion and preparation-of-data algorithms can be considered the backbone of the knowledge stream system. An enabling feature of the knowledge database is its “objectification” and storage of data that allows for the dynamic assembly of blocks of data objects and their rapid transmittal to the screen based on user interaction.

A database design is created that correlates to the knowledge design. Within the knowledge database design buckets, or categories, for data storage are created that map to the storage requirements for the procedures and tasks of the Process Model, the information content for the Reference Information Design and the overall data linking mechanism for the assembly of the knowledge clusters within the user interface.

The database is typically designed with a complete understanding of the resulting interface design which, in turn, springs from the knowledge design of the system. This linkage is an important part of the system creation. The database serves to provide an on-demand supply of knowledge to the user. Thus, each set of objects must be captured and indexed for assembly upon user command.

The database design and database software engine utilized are capable of storing large binary objects of all types. Data is stored in an objectified fashion because the data delivery to the user interface can be totally object oriented. The database houses elements of the screen presentation of the interface. Normal data normalization requirements are a part of the design per standard relational design models.

Following generation of the knowledge database 330 legacy data is converted 340 and deposited in the knowledge database.

Legacy data from a knowledge stream system can exist in a variety of formats: paper, various “snapshot” electronic formats such as PDF, etc. The legacy data can, for example be supplied from an organization desiring the knowledge stream system or can be generally available. Each of the legacy data formats is converted to the knowledge stream-compatible format that is used by the knowledge stream system. Converting the data is typically a multi-step process.

After procurement of legacy data it can be analyzed to understand which one of the many presentation formats it may exist in. The organizational makeup of the content can then be determined. As an example, a technical manual is analyzed for its topical construction, its many sections of graphs, tables, paragraphs of text, diagnostic trees, etc. A general framework is exposed of the content layout of the manual that expresses the style and formatting consistencies of how topics are explained or presented.

From this a set of data object scanning and parsing algorithms can be created for extracting each relevant, discrete object from the legacy content and properly parsing them for inclusion. The guidance system for the algorithms is the knowledge design discussed above.

The algorithms, in conjunction with the results of the Process Model, Reference Information Model and the Conceptual Support Model, act on the legacy data to extract the many content objects from the legacy data depositing them into the proper buckets, or categories, within the database. The “objectification” of the data gives the knowledge stream system high speed, flexibility and dynamic power to assemble a virtually infinite number of knowledge-presenting screen ensembles for the user. For example, the data objects can include graphs, tables, text, schematics, diagnostic trees, and the like.

Once the algorithms have been primed with the new object model a test of the database design is typically conducted before any mass conversion of data is conducted. If the tests indicate the algorithms are accurate and reliable, a larger data conversion run is executed until all conditions seem satisfactory.

The database is then filled by the extraction and depositing of the legacy data objects. For example, paper manuals can be de-splined and run through a high speed scanner with a capability of many thousands of pages per day. Content that exists in some electronic format can be read by the appropriate hardware and software technology and fed into the object template algorithm for dissection. Tests are conducted until the process is fluid and reliable for each legacy data set.

Exception data may exist as a result of the algorithm tests. Exception data includes objects that do not readily fit within one of the knowledge design categories. The exception data can be dealt with by a separate application that allows for the tagging and depositing of odd data objects into the database by the rapid, manual intervention of trained content experts. Exception data that belongs and is deposited in the database then becomes part of the object algorithm for future encounters with that data type alleviating the need to deal with in manually in the future. An average of 20% of all converted legacy data can initially be exception data.

Following conversion of the legacy data 340, the user interface can be implemented 350.

The “face” of the knowledge stream system, that is, the interface of a knowledge stream system, is one of the aspects of the system. To be effective, the knowledge stream system interface design should facilitate human-machine interaction. Because productivity is typically a function of tasks performed in a given time frame, a software interface to a system that positively affects productivity integrates ergonomic efficiency, ease-of-use and bear the ability to provide information with almost flash card expediency. The user can quickly and easily navigate the screens of the system to maintain a pace of activity that augments, not detracts from, the tasks they are to perform. The user interface can include a Graphic User Interface capable of providing the complete spectrum of media types—from simple text to full-motion video. Additionally, the screen layout of the interface possesses a well-designed “frame” orientation similar to how modern Internet web pages are constructed. A frame-based interface allows for the segmentation of the presentation area from the control and feedback areas of each screen. In this way the users eyes become trained to zero-in on pertinent screen areas. Through proper layout and presentation data can be optimally accessed in a manner efficient enough to maintain continuity of thought through the target process or procedures.

The user interface allows the performance support application to be voice-driven. The ability to voice drive the software can exist on two levels. The software can react to short command utterances for screen-to-screen navigation and can receive and process natural language dictation for random notes and data input. Systems that can be voice-driven allow a user to perform multitasking. A user's hands and even eyes can be free to perform tasks, and the worker can be removed from the constraining “computer bubble” traditionally encountered with non-voice systems. As a backup to voice, touch or pen input ability or other form of manual input can be provided.

The user interface can integrate the components of the knowledge Design: the Process Model, the Reference Information Design Model and the Conceptual Support Model. It can also include three screen design elements called the information frame, navigation bar and status bar as will be discussed in further detail below. It can integrate these components in such a fashion that they exist in ergonomic harmony providing easy access to the knowledge data.

When all of the above interface components are present, the performance support interface can become a window or transparent portal to the performance support information. The interface is interactive and can allow the user to perform the task while accessing the data. The user can request and retrieve information without regard to or knowledge of the interface itself. The performance support system can becomes virtually invisible and users are able to experience performance support as if they are actually interacting with a physical mentor guiding them through their tasks.

From a physical layout perspective there are varieties of viable template variations that will work. The user interface typically includes: 1) the Process Model, 2) the Reference Information Model, 3) the Conceptual Support Model, 4) the information frame, 5) the navigation bar and 6) the status bar.

In one embodiment, task-based information and guidance to be displayed to the worker can be provided via a Web browser-equipped display in an information frame. All elements within the frame can be HTML-based. The information frame can include and display the action sequences of the Process Model, the reference information from the Reference Information Model, and the Conceptual Support information. The information frame can be formatted to provide quick absorption by the worker.

The sections of the information frame can be divided up into zones that are each filled with distinct categories of information that can be quickly discerned by the eyes of the worker. For example, at the top of the display the worker sees the major process category of work he or she is involved in. Just below that the actual task at hand is displayed. Any notes or cautions relative to the task can be provided below and highlighted in red to catch the eye.

Task actions can be indicated by a purple arrow followed by a question to be answered if the tasks are part of a diagnostic sequence. Procedure assist sequences can differ in that the worker may not be asked a question as a precipitator of further actions. At the bottom of the information frame are the possible answers to any questions, i.e., Yes or No. This interface layout is designed to condition the eye of the worker so that as the worker gains experience with the system their eyes become trained in the information frame layout and characteristics, allowing a rapid digestion and quick reaction to the information presented.

The navigation bar and status bar round out the remaining elements of the user interface. The navigation bar is, as the name implies, the navigation controls for the interface. The navigation bar can also contain certain other types of controls and access to information as required such as zoom features and a button for conceptual support information access, depending on the interface design. The status bar alerts the worker the status of the system including information related to connectivity.

Upon interaction, the user speaks, touches, provides keyboard or mouse input to direct the flow of information sought. The screen presentation is guided by the servers in the server side hardware and can be delivered via a combination of HTML and XML data streams which is read by the client-side software for display on the user device.

The design of the user interface is typically tested and altered to achieve the ability to: 1) present information in as much a “human-to-human” fashion as possible to emulate a mentoring aspect, 2) to minimize the information-to-knowledge conversion time for the worker, 3) to provide a supreme ease of use and navigation from screen to screen and 4) to test the ability to be interactive on as many different input fronts—voice, touch, etc.—as is possible.

After implementing the user interface 350, the knowledge database is interfaced with the user interface 360. The interface can be performed in the server side hardware.

The interface component of the system can be Web server-based middleware that acts as the intermediary between the database and the user interface. The middleware can consist of set of server objects that dynamically process requests for data and transform those requests into the dynamic assembly of page content for the user interface. These server objects can, for example, provide both information-laced data streams and XML-based streams that populate button bays, button captions, actual information and procedural information.

The dynamic assembly of screen content provides a knowledge transfer advantage of the system. Reaction to such systems show that if workers can achieve and on-demand access to action-specific, context sensitive content that the conversion of that content into knowledge will be quick and painless.

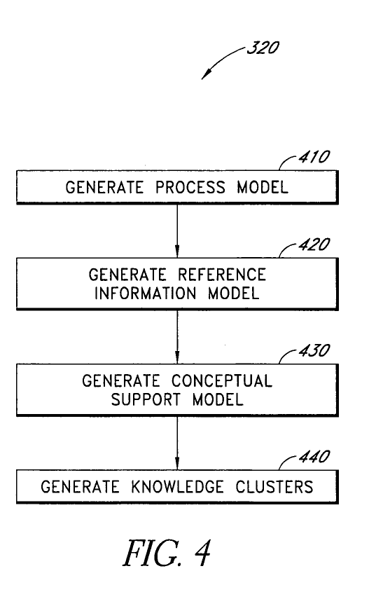

FIG. 4 provides a flowchart of the knowledge design development 320 of FIG. 3. The flowchart process 320 can, for example be embodied as processor readable instructions stored in memory. The development of the knowledge design 320 begins by generating a process model 410.

Research shows that one of the best ways to achieve a knowledge momentum is to provide knowledge associated with specific actions. Research also shows that a stream of knowledge cannot be contiguously absorbed if users are forced to engage in complicated searches or to view long menus or tables of contents to find the data they need.

The process workers engage in is typically task-based. The knowledge stream system uses a task-based approach built around the tasks to be performed as opposed to categories of data. Using a task based approach can assure that progression through the task-based process is logical, ordered, procedure-sequential and navigation-simplified. Yet the system allows novices and experts to choose their own point of access into the process flow, based on their experience and knowledge, to select the desired scope of information required from abbreviated to detail. One aspect of providing a task-based system is development of a Process Model defining the work events and tasks in those events.

The Process Model can reflect the sequence of actions the worker engages in to perform the work event. It provides an information framework by detailing process steps and their functional categories in chronological and/or task-based order. In other words, the process model is the task roadmap mapped into categories of work activity, such as diagnosis of problems, repair, and verification. Developing a process model involves the mapping of the work flow and work environment for a given job. The individual tasks or steps derived from mapping the work flow are then consolidated into categories of work activity. These categories can represent blocks of procedures with a specific purpose relative to the performance of the work events. The labels of the categories themselves can double as the menu labels of the resulting Process Model that gets grafted into the knowledge stream user interface.

A task-based process model usually consists of between five to seven task categories. Further, tasked are categorized as representing a diagnostics process model or a procedure assist process model. If the model is diagnostic, the model can accommodate the conditional branching progression typical of diagnostic models.

After development of the process model 410, a reference information model is generated 420. A Reference Information Model can be assembled that directly compliments the developed Process Model for the system. The reference data provided for the Reference Information Model can be the data or information that directly correlates to the current action the worker is engaged in. For each task or category identified in the Process Model there can be an associated Reference Identification Model. As the worker changes modes and/or progresses through the tasks of the work the body of information of the Reference Information Model changes to accommodate the new actions being performed. For example, within a diagnosis task of a Process Model a corresponding Reference Information Model can identify the steps or tasks involved with the diagnosis, including the type of diagnostic equipment required and the diagnostic steps. The synchronization of the Reference Information Model to the Process Model can account for a major portion of the productivity improvements.

The Reference Information Model is constructed by analyzing customer data, tagging data that directly correlates with the developed Process Model and making that data available in the system for the user on demand. The data is stored in the database and is drawn to the user interface based on where in a task sequence a worker happens to be.

A conceptual support model is also generated 430. The Conceptual Support Model can consist of small “snippits” or vignettes of training or concept explanation for things like how to use a tool or how current flows in a schematic. The data within a Conceptual Support Model is general reference material that a user may desire when progressing through a Reference Information Model.

A Concept Support Model is constructed by analyzing data and training materials applicable to a particular field. The information can be analyzed by tagging those snippits or modules of content that directly supports the Process Model and then making that data available in the system. The data is stored in the database and can be provided to the user interface based on where in a task sequence a worker happens to be.

Once the Process Model, Reference Information Model and Conceptual Support Models have been developed a custom knowledge cluster can be defined and generated 440. A knowledge cluster can be defined as a discrete module of knowledge created from the task, reference and training or conceptual support information associated with a particular task. The knowledge cluster can represent the smallest complete unit of knowledge required to ensure task completion by a worker regardless of knowledge level.

To create a knowledge cluster template, one should remember that the properly designed knowledge cluster provides an envelope of knowledge that surrounds the task with all the support knowledge necessary to achieve that task while, at the same time, keeping the amount of information, or knowledge, to be absorbed small enough to be processed by the worker in a time frame that will not impede the real-time flow of his efforts. A properly designed knowledge cluster can provide the ability to educate in real-time creating a “stream of knowledge” analogous to reading music and playing an instrument simultaneously. It is this guiding, yet user-controllable, stream of knowledge, with its immediate feedback and re-routable progression that simulates the “dedicated mentor” for the worker and can be an advantage of the knowledge stream system.

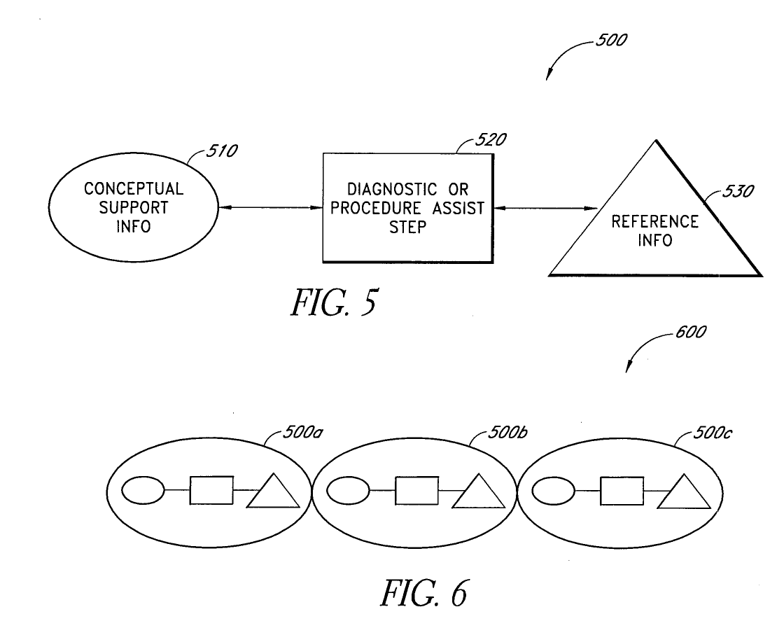

An example of a knowledge cluster 500 is provided in the functional block diagram of FIG. 5. The actual development of a knowledge cluster 500 can be accomplished by linking Process Model, Reference Information Model and Conceptual Support Model components together to form the knowledge cluster 500. The knowledge cluster 500 includes the conceptual support information 510 linked to the step in the task 520 which is also linked to reference information 530. For example, the diagnostic task 520 can be diagnosing a “check engine” warning in an automobile. The conceptual support information 510 can include instructions on how the meter operates. The reference information 530 can include the information related to the actual diagnostic meter reading task, including how to connect the meter to the vehicle and how to operate the vehicle and meter during a test.

The knowledge cluster 500 does not take physical form within the user interface, rather it is represented by the simultaneous presence of the three components of information that come together to create the knowledge cluster 500. The robustness of the knowledge cluster 500 is directly related to the richness of the supplied content making it important to ensure the comprehensiveness of customer data supplied.

Knowledge clusters can then be linked together and presented, in action sequence and at ergonomically acceptable speeds, by the server side hardware to provide a contiguous stream of knowledge to the worker. An example of linked knowledge clusters 500a-500c is provided in FIG. 6. Each of the knowledge clusters 500a-500c can be the knowledge cluster 500 shown in FIG. 5. Alternatively, the knowledge clusters can be presented individually as static images on the user device.

The flowcharts of FIGS. 3 and 4 are further illustrated with reference to a specific example of generating a knowledge stream design for an automotive repair application.

Returning to FIG. 3, the process begins by generating the workflow analysis. Interviews can be conducted with factory and dealer management personnel to understand the scope, breadth and goals of the work of the automotive technician. A focus group of technicians can assembled to receive input from them on their daily activities. Questionnaires on the knowledge design server, in-person interviews and work event or environment analyses sessions can be held to add further understanding.

A knowledge design is then developed 320. Examination of the work flow/work environment data exposes the beginnings of a process model of activities engaged in relative to diagnostic troubleshooting. A formal process model is assembled, with the total system design in mind, targeted at diagnostics activities that can be comprised of six work event categories: 1) Verify Concern, 2) Preliminary Inspections, 3) On-Board Diagnostic (OBD) system check, 4) Diagnostic Test Code (DTC) Diagnosis, 5) Symptom Diagnosis, 6) Repair Verification.

Data is analyzed to expose the reference information available to support the six work event categories. A Reference Information Model is assembled that lists the categories of reference support information. The instructional data, including instructions and work definitions, to accomplish each of the tasks defined in the Process Model is assembled as the Reference Information Model. The Process Model and instructional data of the Reference Information Model can then be stored in memory, for example the server side database. Processor readable instructions can be stored in memory that instruct a server to link the data from the Process Model to the instructional data for the Reference Information Model when the data is requested by a user device.

Data is reviewed again and another round of interviews can be conducted with customer training personnel and service management personnel to determine the availability of certain types of training material from which could be built a Conceptual Support Model. After further scrutiny a Conceptual Support Model is assembled that provides blocks of just-in-time training tied directly to the Process Model task elements. The Conceptual Support Model includes the reference material related to the performance of the tasks in the Reference Information Model. The reference data corresponding to the Conceptual Support Model can also be stored in the database, or some other processor accessible memory, and linked to the Process Model data by a processor operating on processor readable instructions.

With the above three elements of the knowledge design defined, an examination of the efficiency of the data combinations can be conducted. A simulation is assembled to test the effectiveness of the three elements working together to see if there is enough harmony in their interaction to qualify as a knowledge cluster for each work event set within the system. The testing is satisfied if there is a simultaneous occurrence of task, reference and conceptual support information available when need by the technician. Satisfied with the results the knowledge Design is finished until further testing later within the actual user interface.

The knowledge database is then generated 340. The process, reference and concept pieces available and necessary to deliver the diagnostic information to the technician are analyzed. At this point the database design can be executed. The database can be designed to store, for example, text, graphic, table, and binary objects. Special consideration can be given to storage of XML objects that serve to populate the button bays of the user interface and certain information streams. A processor operating in a server running the knowledge stream application can access the database to retrieve the data objects and transmit them to the user device.

After design of the database, legacy data can be converted and stored in the database 340. For this example a section of legacy data that references diagnostics routines is targeted for conversion and inclusion in the database. A set of paper manuals can be the source of the legacy data.

A scanning algorithm or engine can be developed to accept a scanned data stream of page objects from a high speed scanner and drop them into a holding area within the database architecture. For example, the algorithm examines the incoming scanner data stream and segments the stream into pieces of graphical or textual, or combinations of text and graphical “objects” where whole, complete blocks of text (theory of operation, diagnostic code set conditions, circuit descriptions, etc.), graphics (schematics, engine parts locations, etc.) figures (pictures of ignition parts, etc.), tables (diagnostic tables, voltage value tables, etc.), etc. are dissected from the whole.

A set of database parsing algorithms can be used that have the ability to accept extracted objects from the pages of technical manuals and deposit them in the proper database buckets within the database. The algorithms are stored in processor readable memory and accessed and operated on by the processor controlling the data extraction.

This set of algorithms accomplishes two things: 1) to examine each object and determine its binary composition such as whether it is indeed a text block with its own descriptive header that can be read by an OCR (optical character recognition) routine to understand what the text block refers to, and 2) to act on a set of rules springing from the knowledge design that will actually deposit the objects into appropriate, indexed locations within the database enabling them to be drawn to the interface based on user interaction. Rules are provided as guidance to the parsing algorithm. As described earlier the knowledge design can provide, among other things, a complete, conceptual data map of what will be needed by the user once the system is operational. Thus the knowledge design provides the basis for the rules set the parsing algorithm requires.

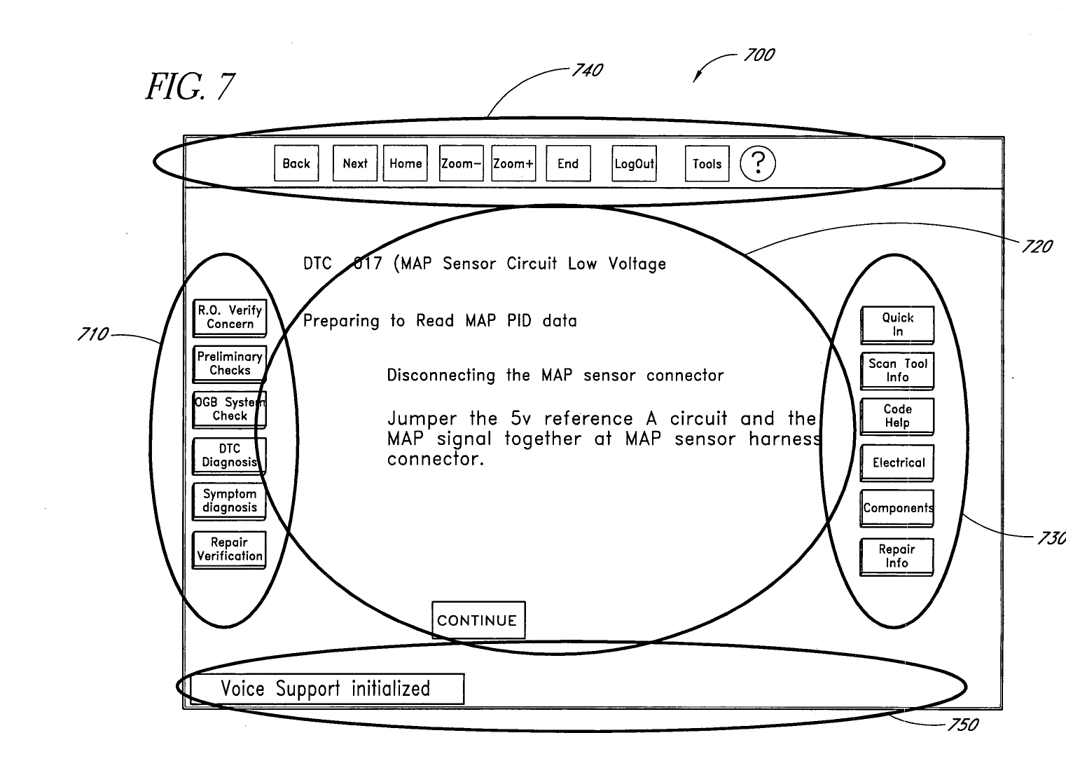

The user interface assembly implementation 350 begins by identifying the shape and location of the Process Model buttons, Reference Information Model buttons and any Conceptual Support buttons that will appear within the interface. An example of the user interface display 700 is shown FIG. 7. The user device can implement a process stored in memory as processor readable instructions that is operated by a processor running the process. The processor readable instructions can instruct the processor to control the user device to retrieve and display the data.

For this example the Process Model buttons 710 will occupy a button “bay” on the left side of the Graphical user interface layout that begins with a blank screen. Each of the Process Model buttons 710 identifies a category of task in the work event. The process model data corresponding to the process model buttons are retrieved from the remote database by the user device.

The information frame of the interface 720, that zone that displays the pertinent task, reference and concept information, occupies the center majority of the interface real-estate. The information displayed in the information frame can, for example be a portion of the instructional data of the Reference Information Model retrieved from the database. The Reference Information Model buttons 730 occupy a vertical zone on the right side of the interface palette. Each of the Reference Information Model buttons 730 is an identifier of informational data relating to at least one of the Process Model buttons. The navigation bar 740, the series of buttons that allow screen movements, zooming, etc., are placed at the top horizontal section of the screen. The status bar 750 is positioned at the bottom of the screen and provides information on system status and connectivity to data sources.

The information frame 720 is designed to give the presented information a sectional specialty. The sections of the information frame 720 are divided up into zones that are each filled with distinct categories of information that can be quickly discerned by the eyes of the worker. As noted earlier, the processor can access machine readable instructions to run an application that retrieves the appropriate instructional data for display in the information frame. At the top of the information frame 720 the major process category of work he or she is involved in. Just below that the actual task at hand is displayed. Any notes or cautions relative to the task are provided next, and in red, to catch the eye. Next are task actions indicated by a purple arrow followed by a question to be answered if the tasks are part of a diagnostic sequence. Procedure assist sequences differ in that the worker may not be asked a question as a precipitator of further actions. At the bottom of the information frame 720 are the possible answers to any questions, i.e., Yes or No. This interface layout is designed to condition the eye of the worker so that as the worker gains experience with the system their eyes become trained in the frame's layout and characteristics allowing a rapid digestion and quick reaction to the information presented.

Based on an environmental analysis, a speech engine is provided along with input options of touch, keyboard and mouse. For the automotive example a color tablet computer can be the user device platform of choice.

The server side hardware links the user device to the database. The server side hardware is designed to react to the commands generated by the user device, whether originating through speech command, screen presses, or mouse clicks, and to retrieve data from the database, link the data, and provide it to the user interface. Data can delivered from the database by a high-speed Web server in one or both of two formats: HTML or XML. This format can ensure a high throughput within the system.

With a completed system in hand the technician can interact to acquire the knowledge needed to accomplish the given task of troubleshooting a “service engine” light on the dash of the suspect vehicle.

For example the first thing the technician does is begin by pressing the “DTC Diagnosis” button on the tablet screen of the user device. After connecting the tablet to the on-board computer system of the auto the technician presses the “READ CODES” button on the screen to request the DTC codes from the on-board diagnostic system. A “P0107” code, for example, can be returned from the ailing auto. The technician selects the code on the tablet screen to initiate a diagnostic guidance from the knowledge stream system.

Once the code number has been selected the interface is laced with diagnostics task guidance, reference information and any conceptual support info. In the case of the P0107 code a thirteen step guidance system is provided one task-based screen for guidance at a time. In addition there are reference information buttons providing six major categories and twenty different sub-categories of information to support the tasks. The technician progresses from task to task completing the tasks using both the reference info and the training snippits, as needed, to complete the tasks.

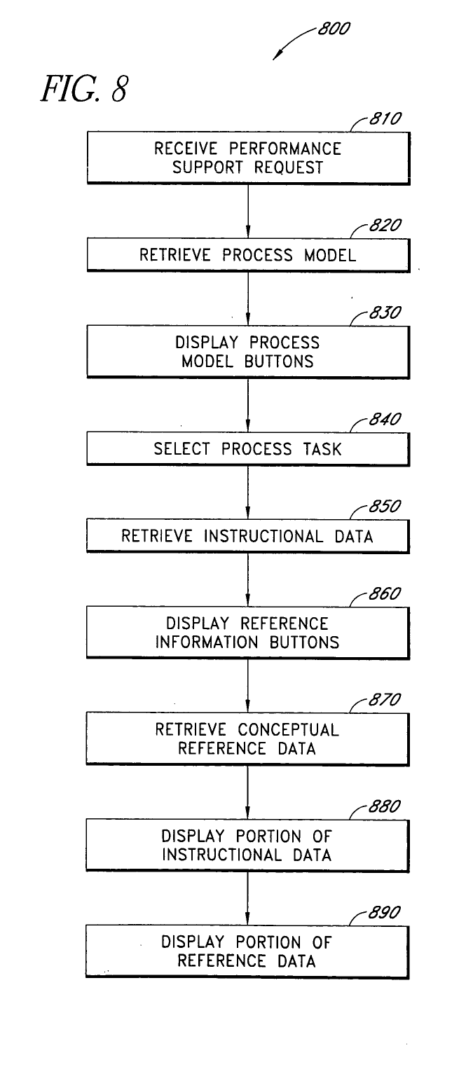

FIG. 8 is a flowchart of a process that can run on the user device, such as the user device of FIG. 2 or one of the user devices of FIG. 1. The process 800 can be implemented as processor readable instructions that are stored in memory and operated on by the processor. Alternatively, modules or modules in combination with a software controlled process can be used to perform the process 800.

The user device begins by receiving a performance support request 810, such as by receiving a support request via the user interface. The user device proceeds to block 820 where the process model for the task is retrieved. The process model can, for example, be retrieved from local memory within the user device or can be retrieved from the remote database using a network connection to the server side hardware. The data that is retrieved from remote memory is then stored in the local memory.

The user device then proceeds to block 830 where the process model buttons identifying the categories in the process model are displayed. The user device then proceeds to block 840 where a process task is selected. The selection can be automated in the user device or can be in response to a user selection of a process model button.

The user device proceeds to block 850 where the instructional data corresponding to the reference information model is retrieved. This data can be retrieved from local memory within the user device or retrieved from the remote database and stored into local memory.

The user device proceeds to block 860 where the reference information buttons that correspond with the process model are displayed. The user device proceeds to block 870 where the conceptual reference data is retrieved from local or remote memory. The refemce data corresponds with the conceptual support model associated with the process model and reference information model. The user device, in block 880, can then display a portion of the instructional data previously retrieved. The portion that is displayed can correspond to a particular task in the process model selected by the user of the device. Additionally, the user device, in block 890, can display a portion of the reference data. For example, the user device can display a portion of the reference data that corresponds with a selection provided by the user.

The blocks in the process 800 are shown in a particular order, although the specific order is not a requirement. For example, all of the data corresponding to the process model, reference information model, and conceptual support model can be retrieved prior to displaying any of the buttons. Additionally, the instructional or reference data may not be displayed simultaneously or may not be displayed at all.

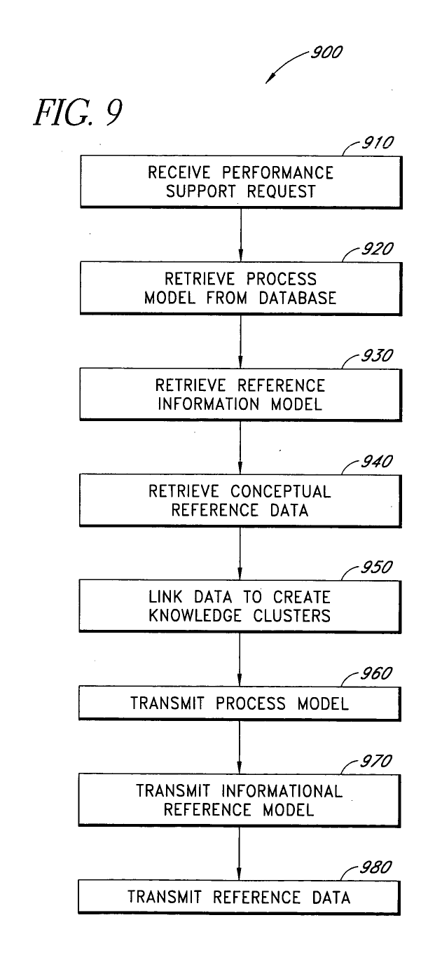

FIG. 9 is a flowchart of a complementary process 900 that can run on the server side hardware. The process 900 can be performed by dedicated hardware or hardware in conjunction with software. The software can be processor readable instructions stored in one or more devices for operation by one or more processors.

The process begins at block 910 where the server side hardware receives a performance support request. The request can be generated, for example, by one of the user devices shown in FIG. 1. The request can be received over a network connection, such as a wired connection or a wireless connection.

The server side hardware proceeds to block 920 where the process model is retrieved from the database. The server side hardware proceeds to block 930 where the reference information model is retrieved from the database. This can include retrieving the instructional data corresponding to the reference information model associated with the process model.

The server side hardware next proceeds to block 940 where the conceptual reference data is retrieved from the database. The reference data can correspond to a conceptual support model associated with the reference information model.

In block 950, the server side hardware links together the process model, reference information model, and reference data from the conceptual support model. The linked knowledge clusters are then transmitted to the user device.

In block 960, the server side hardware transmits the process model. In block 970, the server side hardware transmits the reference information model including the instructional data. In block 980, the server side hardware transmits the reference data corresponding to the conceptual support model.

The server side hardware thus is able to respond to performance support requests by retrieving and transmitting to the user device the required knowledge to support the tasks or procedures performed by a user. The data is linked in such a manner to provide a knowledge stream that corresponds with the particular work events encountered by the user in the performance of tasks.

The user device, in conjunction with the other elements of the knowledge stream system provides a structured knowledge tool that serves as an extension to the experience and knowledge of the worker, or as a source of knowledge in lieu of any prior experience. Productivity improvements of in excess of 30% are possible and likely with an increase in overall accuracy. In addition, novice workers or even personnel who may have been, for whatever skill or social issues, previously unemployable, will now be able to attack complex troubleshooting of complicated systems with little or no training or previous experience.

Electrical connections, couplings, and connections have been described with respect to various devices or elements. The connections and couplings can be direct or indirect. A connection between a first and second device can be a direct connection or can be an indirect connection. An indirect connection can include interposed elements that can process the signals from the first device to the second device.

Those of skill in the art will understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present invention.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

1. An interactive computerized support system comprising:
a user interface configured to display a group of work categories identifying a sequence of tasks, and to accept a user input for a desired task from the sequence of tasks;
a processor configured to retrieve from a remote database instructional data associated with the desired task, and to retrieve, from the remote database, reference data, the processor further configured to selectively provide the instructional data and reference data to the user interface for display.

2. The system of claim 1, wherein the user interface is further configured to display the group of work categories as a first group of selectable buttons and identifiers for the instructional data as a second group of buttons.

3. The system of claim 1, wherein the user interface further comprises a remote interface configured to accept a request for instructional data from the processor and access the remote database over a network connection to retrieve the instructional data.

4. The system of claim 3, wherein the network connection to the remote interface comprises a wireless communication link.

5. The system of claim 1, wherein a portion of the instructional data is linked with a portion of the reference data and the portion of the instructional data is linked to a one of the group of work categories.

6. The system of claim 1, wherein the instructional data is retrieved as a linked group of data objects.

7. The system of claim 6, wherein the group of data objects comprises a diagnostic tree.

8. The system of claim 6, wherein the group of data objects comprises a schematic.

9. The system of claim 6, wherein the group of data objects comprises text.

10. The system of claim 1, wherein the user interface comprises:
a microphone configured to accept user voice commands; and
a speech recognition module configured to convert the user voice commands to electronic requests that are provided to the processor.

11. The system of claim 1, wherein the user interface comprises a manual input configured to accept the user input.

12. The system of claim 1, wherein the group of work categories comprises a group of automotive repair tasks.

13. The system of claim 1, wherein the instructional data comprises support data for an automotive repair task identified in the group of work categories.

14. An interactive computerized support method, the method comprising:
receiving a request for support data for a work event;
receiving, from a remote database, a group of work categories identifying a sequence of tasks corresponding to the work event;
receiving, from the remote database, instructional data linked to the group of work categories; and
displaying a portion of the instructional data.

15. The method of claim 14, further comprising displaying, as a first group of buttons, identifiers for the group of work categories.

16. The method of claim 15, further comprising displaying, as a second group of buttons, identifiers for the instructional data.

17. The method of claim 14, wherein receiving instructional data comprises:
receiving instructional data objects corresponding to each of the group of work categories; and
receiving reference data objects linked to the instructional data objects.

18. The method of claim 14, wherein receiving the request for support data comprises receiving a request for support of an automotive repair task.

19. The method of claim 14, wherein receiving the group of work categories comprises receiving the group comprising:
verifying concern;
preliminary inspections;
diagnosis of fault; and
repair of fault.

20. The method of claim 14, further comprising:
receiving a request for a desired task from the sequence of tasks; and
displaying a data object linked to the desired task from the instructional data in response to the request for the desired task.
